(19) United States
(12) Patent Application Publication
(10) Pub. No.: US 2026/0288453 A1
(43) Pub. Date: Sep. 24, 2026

(54) SOFTWARE DEVELOPMENT FRAMEWORK ENHANCEMENT TO SUPPORT CUSTOMIZED CODE GENERATION

(71) Applicant: Microchip Technology Incorporated, Chandler, AZ (US)

(72) Inventor: Karthikeyan Jegatheesan, New Perungalathur (IN)

(73) Assignee: Microchip Technology Incorporated, Chandler, AZ (US)

(21) Appl. No.: 19/273,270

(22) Filed: Jul. 18, 2025

(30) Foreign Application Priority Data
Mar. 20, 2025 (IN) 202511025101

(51) Int. Cl. G06F 8/70; G06F 8/34; G06F 8/41; G06F 8/65

(52) U.S. Cl. CPC G06F 8/70; G06F 8/34; G06F 8/41; G06F 8/65

(57) ABSTRACT

A processor may access multiple templates related to an initial firmware version. The processor may identify a customized value within the first template. The processor may generate source code for a second firmware version based on the template. This source code includes indications of the customized value found in the first template, enabling the creation of an updated firmware version while retaining specific customizations from the original.

### CROSS-REFERENCE TO RELATED APPLICATIONS

This application claims the benefit of priority to Indian Patent Application No. 202511025101, filed on March 20, 2025, which is incorporated herein by reference in its entirety.

### BACKGROUND

Hardware manufacturers may provide software for devices, such as firmware serving as an intermediary between the device hardware and higher-level software applications. It is common for hardware manufacturers to update their firmware to enhance functionality, improve performance, and address security vulnerabilities. Additionally, new hardware devices are frequently introduced to replace older models, offering advanced features and improved capabilities.

One challenge includes the integration of customizations and business logic into new firmware releases or new hardware devices. For example, specific business logic may be integrated into the firmware. However, when a new firmware or a new device is introduced, these customizations are not automatically ported over. Instead, these customizations may be overwritten or reported as merge conflicts.

### BRIEF SUMMARY

In one or more examples, a method comprises a processor accessing multiple templates associated with a first version of firmware. The processor may identify a first customized value within a first template of the plurality of templates. The processor may generate source code for a second version of the firmware based on these templates, where the source code includes an indication of the first customized value found in the first template.

In one or more examples, a non-transitory computer-readable storage medium stores instructions that, when executed by a processor, direct the processor to access multiple templates related to a first version of firmware. The processor may identify a first customized value within a first template, and create source code for a second version of the firmware that incorporates an indication of the first customized value.

In one or more examples, an apparatus comprises a processor and memory that stores instructions. When these instructions are executed by the processor, they facilitate accessing a plurality of templates associated with a first firmware version, identifying a customize value in a specific template, and generating source code for a second firmware version that reflects the customized value.

The features, functions, and advantages that have been described herein may be achieved independently in various examples of the present disclosure including computer-implemented methods, computer program products, and computing systems or may be combined in yet other examples, further details of which can be seen with reference to the following description and drawings.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

Reference will now be made to the accompanying drawings, wherein:

FIG. 1 illustrates an aspect of the subject matter in accordance with one example.

FIG. 2 illustrates an aspect of the subject matter in accordance with one example.

FIG. 3 illustrates an aspect of the subject matter in accordance with one example.

FIG. 4 illustrates an aspect of the subject matter in accordance with one example.

FIG. 5 illustrates an aspect of the subject matter in accordance with one example.

FIG. 6 illustrates an aspect of the subject matter in accordance with one example.

FIG. 7 illustrates a logic flow 700 in accordance with one example.

FIG. 8 illustrates a logic flow 800 in accordance with one example.

FIG. 9 illustrates a computing system 900 in accordance with one example.

### DETAILED DESCRIPTION

According to various examples disclosed herein, a software development framework may provide features to integrate customized business logic across any number and type of software development projects. Generally, a manufacturer of hardware (including, without limitation, circuits, microcontrollers, or transceivers) may provide software for the hardware. For example, the software provided by the manufacturer may include firmware for the hardware, drivers for the hardware, or any type of software. The software may include static features that cannot be configured by the end user (which may be referred to as a “base configuration” herein). Similarly, the software may include one or more dynamic features that may be customized by the user (which may be referred to as an “advanced configuration” herein). When the user makes desired customizations, these customizations may be stored in one or more output files (e.g., templates) that are in turn may be used to generate source code for the software. The source code may then be compiled to generate executables, where the source code and the executables include the customizations.

In some examples, users may add one or more customizations via a graphical user interface. Examples of customizations include, but are not limited to, custom variables, specific values for variables, custom data types, tasks, unified modeling language (UML) objects (e.g., diagrams), pseudocode, interrupt handling, state machines, state machine handling, grouping of messages, grouping of events, registering callbacks for enabled events, separating application functions based on technology or peripherals, configurable peripheral-based trigger support, and sleep support. In some examples, the templates are stored as FreeMarker Template Language (FTL) files. In some examples, the templates define the structure and content of the code to be generated. The templates may contain one or more placeholders for one or more customizable values. In some examples, one or more scripts may dynamically insert specific values and code snippets based on the user configuration.

In some examples, the customizations may be integrated into other software development projects. For example, the customizations may be integrated into a new version of software for the device, or into software for a new device being used (e.g., a different device).

In some examples, one or more scripts may facilitate the integration of the customizations into the other software projects. For example, the scripts may search for and return a list variables, interfaces, and functions in the templates. In some examples, the scripts may add the identified information into the other software projects, thereby aiding in the incorporation of custom logic. As stated, in some examples, the scripts may generate the source code for the other software projects, e.g., by parsing the templates, filling in the placeholders with the user-specified values, and produce the output source code files.

In some examples, artificial intelligence (AI) features may further streamline the process. In some examples, AI may convert the user customizations, such as variables, UML, or pseudocode, into business logic or source code, significantly reducing proof-of-concept time and manual intervention.

Advantageously, the disclosure may ensure that customer business logic is preserved and easily integrated into new framework versions. Doing so makes it easier for users to integrate their business logic and migrate to new versions of hardware or software, providing flexibility as the number of software versions and device versions increase to numbers that cannot be feasibly managed manually. Furthermore, doing so may reduce software development time and reduce the amount of resources to develop software. In some examples, the disclosure supports providing the software as a service. More generally, in some examples, migration efforts are reduced, merge code conflicts are reduced, business logic is preserved, and a seamless integration experience is provided.

Aspects of the present disclosure and certain features, advantages, and details thereof are explained more fully below with reference to the non-limiting examples illustrated in the accompanying drawings. Descriptions of processing techniques, systems, or components are omitted so as to not unnecessarily obscure the disclosure in detail. The detailed description and the specific examples, while indicating aspects of the disclosure, are given by way of illustration, and not by way of limitation. Various substitutions, modifications, additions, or arrangements, within the spirit or scope of the disclosed aspects will be apparent from this disclosure. Note further that numerous aspects and features are disclosed herein, and unless inconsistent, each disclosed aspect or feature is combinable with any other disclosed aspect or feature as desired for a particular example of the concepts disclosed herein.

Unless described or implied as exclusive alternatives, features throughout the drawings and descriptions are cumulative, such that features expressly associated with some particular examples can be combined with other examples. Like numbers refer to like elements throughout.

While certain examples have been described and shown in the accompanying drawings, it is to be understood that such examples are merely illustrative of, and not restrictive on, the broad disclosure, and that this disclosure not be limited to the specific constructions and arrangements shown and described, since various other changes, combinations, omissions, modifications and substitutions, in addition to those set forth in the above paragraphs, are possible. Various adaptations, modifications, and combinations of the herein described examples can be configured without departing from the scope and spirit of the disclosure. Therefore, it is to be understood that, within the scope of the included claims, the disclosure may be practiced other than as specifically described herein.

Additionally, illustrative examples are described below using specific code, designs, architectures, protocols, layouts, schematics, or tools as examples, and not by way of limitation. Furthermore, the illustrative examples are described in certain instances using particular software, tools, or data processing environments for clarity of description. The illustrative examples can be used in conjunction with other comparable or similarly purposed structures, systems, applications, or architectures. One or more aspects of an illustrative example can be implemented in hardware, software, or a combination thereof.

Program code, as referred to in this application, can include both software and hardware. For example, program code in certain examples can include fixed function hardware, while other examples can utilize a software-based implementation of the functionality described. Certain examples combine both types of program code.

The terms “coupled,” “fixed,” “attached to,” “communicatively coupled to,” “operatively coupled to,” and the like refer to both (i) direct connecting, coupling, fixing, attaching, communicatively coupling; and (ii) indirect connecting coupling, fixing, attaching, communicatively coupling via one or more intermediate components or features, unless otherwise specified herein. “Communicatively coupled to” and “operatively coupled to” can refer to physically or electrically related components.

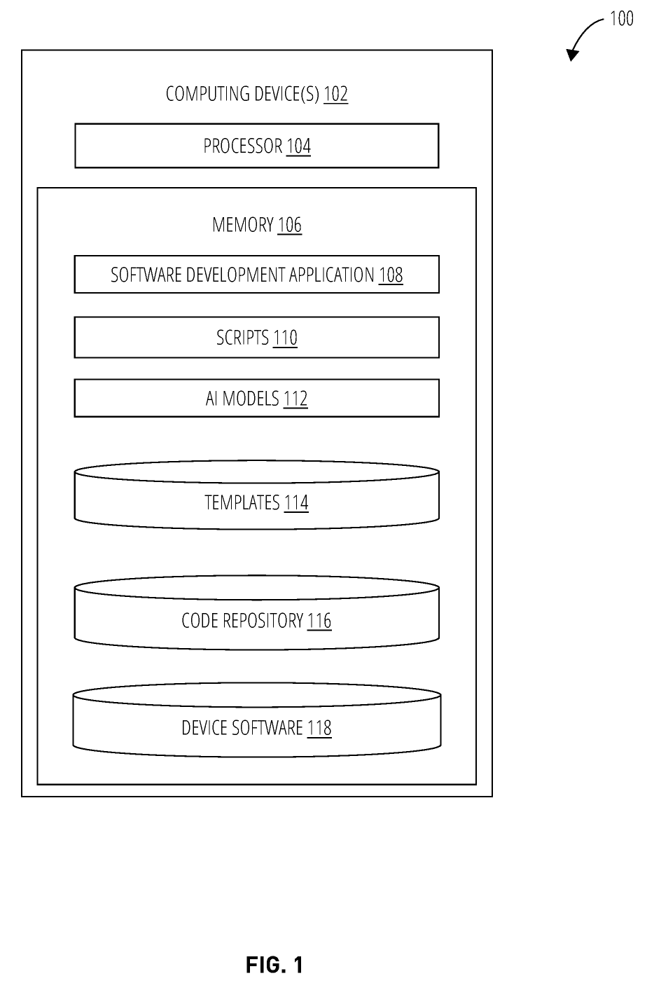

FIG. 1 illustrates a system 100 according to various examples. As shown, the system 100 includes one or more computing devices 102. The computing devices 102 are representative of any type of physical or virtualized computing system, including without limitation, a server, workstation, laptop, mobile device, smartphone, tablet computer, mainframe, distributed computing system, compute cluster, media device, camera, gaming device, a virtual machine (VM), or a container. The computing devices 102 include one or more processors 104 for executing instructions and at least one memory 106 for storing instructions. Although depicted as being components of a single device, the components of the computing device 102 may be spread across multiple instances of computing devices 102.

As shown the memory 106 includes a software development application 108, one or more script 110, one or more AI models 112, a data store of templates 114, a code repository 116, and a data store of device software 118. The software development application 108 is an integrated development environment (IDE) to develop software such as source code in the code repository 116 or executable software in the device software 118. Examples of the software development application 108 include, but are not limited to, the MPLAB® Harmony v3 integrated embedded software development framework. Generally, the software development application 108 may provide flexible and interoperable software modules to facilitate software development. In some examples, the software development application 108 is used to develop firmware, drivers, controller code, or any type of software for devices such as microcontrollers and microprocessors.

Often, a manufacturer of hardware (or a vendor associated with the manufacturer) may develop base versions of device software such as firmware or drivers. The base versions may provide base configurations for the device. In some examples, the base versions are implemented via one or more templates 114 for the device. The templates 114 may therefore include template files for a plurality of devices, which may include a plurality of templates for a given device or version of device. In some examples, the templates 114 include FreeMarker Template Language (FTL) files. In some examples, FTL files in the templates 114 define the structure and content of the source code to be generated based on the templates 114. In some examples, the templates 114 contain placeholders and logic to dynamically insert specific values and code snippets based on user input and configuration. In some examples, the templates 114, code repository 116, or device software 118 are publicly available, e.g., via a development platform such as GitHub.

One or more users may use the software development application 108 to provide further customizations to the base configuration of the software. For example, the further configurations may include advanced configuration for the software or underlying device. For example, the user may specify, as advanced configuration, one or more configurable parameters. Examples of the advanced configuration include, but are not limited to, custom variables, specific values for variables, custom data types, tasks, unified modeling language (UML) objects (e.g., diagrams), pseudocode, interrupt handling, state machines, state machine handling, grouping of messages, grouping of events, registering callbacks for enabled events, separating application functions based on technology or peripherals, configurable peripheral-based trigger support, and sleep support.

For example, for a Bluetooth® transceiver, a user of the software development application 108 may specify timeout values or wakeup functions. When the user finalizes the advanced configuration, the software development application 108 may save the advanced configuration in one or more customized FTL files in the templates 114. Therefore, the templates 114 may include configurable business logic provided via the advanced configuration.

In some examples, source code may be generated based on the files for a software development project in the templates 114. The generated source code may be stored in the code repository 116. In some examples, one or more scripts 110 may be used to generate the source code based on the templates 114, e.g., to dynamically insert specific values and code snippets and generate source code that is stored in the code repository 116. The scripts 110 may include any type of executable script, including but not limited to Python scripts.

The source code in the code repository 116 may then be compiled to generate one or more executable files that are stored as the device software 118. Examples of the device software 118 include firmware, drivers, images, or any type of software. The device software 118 may then be provided to execute on the corresponding hardware.

Often, the base configuration of the device software may be updated via one or more updates by the manufacturer. For example and without limitation, the manufacturer may offer new features, deprecate features, or fix errors. Similarly, new devices or new versions of devices may be offered with corresponding base configurations of device software. However, simply using the base configuration would not incorporate the advanced configuration defined in the templates 114.

Advantageously, the software development application 108 is configured to integrate the advanced configuration in the templates 114. Generally, when working with the new version of a base configuration of software (or a base configuration for a new type or version of hardware), the software development application 108 may facilitate the integration of the advanced configuration in the templates 114.

For example, a user may specify the location of the advanced configuration in the templates 114 or add further advanced configuration via the software development application 108. When migrating to a new version, the software development application 108 may depict modifications and conflicts. Users may approve changes, ensuring their custom logic is preserved and integrated. In some examples, one or more of the scripts 110 may be executed to list variables, interfaces, and functions from the templates 114, aiding in the integration of custom logic specified in the advanced configuration provided by the user.

In some examples, the scripts 110 may parse the files for the project in the templates 114 to identify and list all elements that constitute the customized logic in the advanced configuration specified by the user. Once the custom logic is extracted, the scripts 110 may generate templates that define the structure and content of the code to be integrated into the new firmware. These templates 114 include placeholders for the extracted elements, ensuring that the advanced configuration is preserved.

In some examples, the scripts 110 detect potential conflicts between the existing custom logic and the new base code configuration. These conflicts may arise due to changes in the firmware’s structure or functionality. The scripts 110 may highlight these conflicts and provide mechanisms for users to resolve them, such as approving modifications or merging changes.

In some examples, the scripts 110 automate the generation of the new firmware code by filling in the placeholders in the FTL templates 114 with the extracted custom logic. This automation reduces manual intervention and ensures that the custom logic is accurately integrated into the new firmware.

After generating or storing the new code in the code repository 116, the scripts 110 may compile the code into executable software, e.g., the device software 118. This compiled code includes the user’s advanced configuration, seamlessly integrated with the new functionalities provided by the base configuration. The integration process ensures that the customizations are preserved and function correctly in the new environment.

In some examples, the advanced configuration specified by the user and saved in one or more templates 114 may be merged into different projects via the software development application 108. In some examples, the software development application 108 may compare the advanced configuration in the templates 114 with the base configuration. The difference of the advanced configuration and the base configuration may be stored as one or more templates 114. Doing so allows the difference (e.g., the advanced configuration) to be merged into the different projects.

In some examples, code in the code repository 116 may be generated by one or more AI models 112. The AI models 112 are representative of any type of AI model, including, without limitation, neural networks, large language models (LLMs), or machine learning models. The AI models 112 may generate code based on the templates 114, which may include the advanced configuration specified by the user. The AI models 112 may be trained to generate source code. For example, the AI models 112 may be trained on training data that includes, but is not limited to, the templates 114 (including base configuration and any advanced configuration), source code in the code repository 116, or executables in the device software 118. The AI models 112 may convert user inputs, such as text, UML diagrams, or pseudocode in the templates 114, into business logic in source code or any other type of logic. The logic generated by the AI models 112 may then be processed by one or more of the scripts 110 to generate source code that may be stored in the code repository 116. The code in the code repository 116 may be compiled and integrated into the firmware, e.g., the device software 118, further reducing development time and manual effort.

In one example, the device software 118 may include a first firmware version for a first embedded device. This first firmware version includes advanced configuration such as business logic and customizations tailored to operational needs, including but not limited to as custom variables, tasks, and state machines. These customizations are defined using a set of templates 114. When a second firmware version is released for the device, the developer of the advanced configuration may face the challenge of migrating their customizations without losing functionality or introducing errors.

To migrate the customizations to the second firmware version, one or more of the scripts 110 may extract the custom logic from the FTL templates 114 used in the first firmware version. The scripts 110 may use the templates 114 to generate source code compatible with the second firmware version, ensuring that the advanced configuration in the templates 114 is accurately preserved. During this process, the scripts 110 may detect any potential conflicts between the existing custom logic and the new firmware code, providing mechanisms for resolving these conflicts.

The scripts 110 may then generate the source code based on the templates 114, filling in the placeholders in the templates 114 with the extracted custom logic to generate the source code. The resulting source code may be stored in the code repository 116. The code may be compiled into executables for the second version of the firmware in the device software 118. This automated approach ensures that the customizations are seamlessly integrated into the new firmware, maintaining consistent performance and functionality. The migration framework significantly reduces the time and effort for the upgrade, allowing the developer to quickly adopt the new firmware version while preserving their business logic.

In some examples, the software development application 108 may include features to create one or more software development project files, open one or more project files, save one or more templates 114, open templates 114, and parse the templates 114. Generally, to parse files such as the templates 114, the software development application 108 (which may include the scripts 110) may identify functions, variables, interfaces, structures, enumerations, and other information stored in the templates 114, e.g., at least a portion of advanced configuration. The software development application 108 may return lists or other indications of the parsed information, e.g., for acceptance, conflict resolution, or modification. In some examples, the software development application 108 automatically imports the advanced configuration into a project. In some examples, the software development application 108 may detect and highlight modifications or impacts on the existing application based on importing the advanced configuration. The user may use the software development application 108 to merge changes and resolve any conflicts. Further still, the software development application 108 includes one or more interfaces allowing users to define advanced configurations for a project, such as custom variables, tasks, UML diagrams, or state machines.

The software development application 108 may further include logic to generate templates 114 (e.g., FTL files) defining the structure and content of code to be generated. Similarly, the software development application 108 may include mechanisms to process the templates 114 and generate source code. As stated, in some examples, the software development application 108 may leverage the AI models 112 to convert user inputs such as UML diagrams or pseudocode, into business logic and source code.

The software development application 108 may include one or more migration tools, e.g., to migrate advanced configuration in one or more prior projects to one or more other projects. Doing so ensures custom business logic is preserved and integrated during migration. Examples are not limited in these contexts.

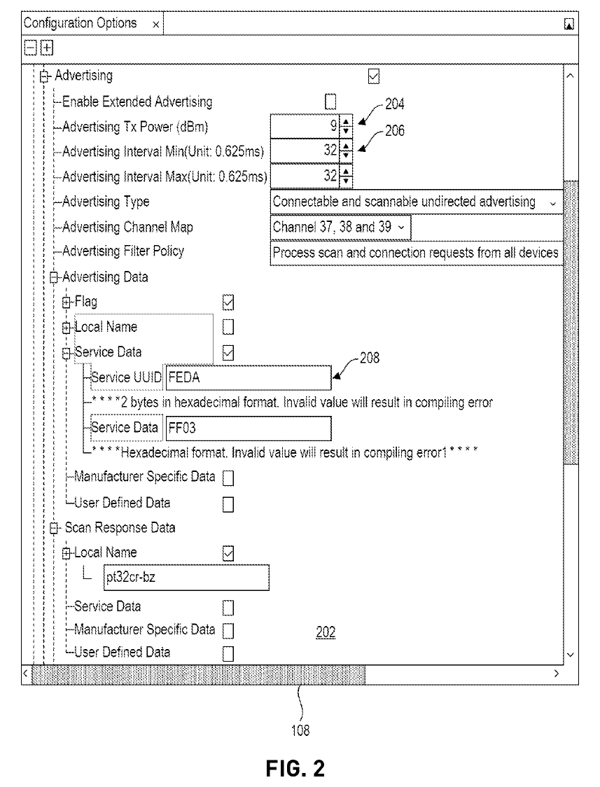

FIG. 2 illustrates an example graphical user interface 202 of the software development application 108, according to various examples. As shown, the graphical user interface 202 includes a plurality of input fields including a field 204, a field 206, and a field 208. The input fields 204-208 are configured to receive customized values, e.g., user-specified advanced configuration for a software development project. In some examples, the input fields may reflect a base configuration of the software development project, e.g., predefined values in a firmware project or a driver projects. However, in some examples, the input fields may not have associated values as part of the base configuration.

For example, the user may provide input into one or more input fields 204-208. As shown, input field 204 may correspond to an advertising power for a wireless transceiver, input field 206 may correspond to a minimum advertising interval, and input field 208 may correspond to a unique service identifier. Although depicted as receiving alphanumeric input, the fields 204-208 may be configured to receive any type of input for the advanced configuration. For example, and without limitation, the input types for the advanced configuration may include UML files, pseudocode, or scripts.

Once the user specifies the desired advanced configuration, e.g., via one or more of the input fields 204-208 (or other input fields of the software development application 108), the user may generate an output including one or more templates 114. In some examples, the templates 114 are generated by the software development application 108. The templates 114 may include one or more template files with the user specified values in input fields 204-208 or any other user-specified advanced configuration values. One or more scripts 110 may then generate source code based on the templates 114 and store the source code in the code repository 116. In some examples, the software development application 108 generates the source code based on the templates 114 and stores the source code in the code repository 116. The source code may then be compiled to generate one or more objects such as firmware or device drivers that are stored in the device software 118.

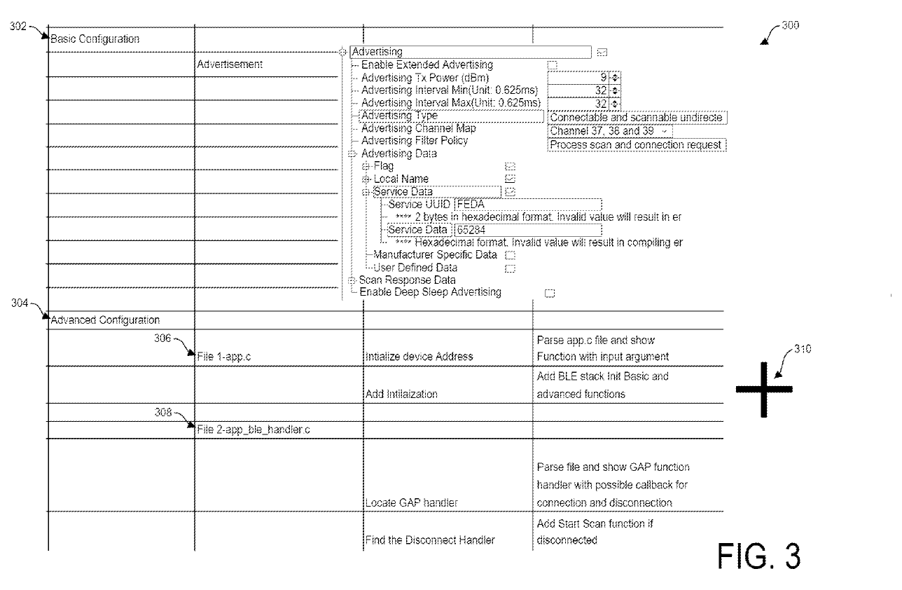

FIG. 3 illustrates an example graphical user interface 300 of the software development application 108, according to various examples. As shown, the graphical user interface 300 depicts a base configuration 302 and an advanced configuration 304 of a software development project.

As stated, the base configuration 302 may include predetermined configurations, e.g., configurations provided by a manufacturer of a device, while the advanced configuration 304 may include user-specified configurations. For example, the advanced configuration 304 may include a file 306 and a file 308 (e.g., one or more of the templates 114 with advanced configuration). The advanced configuration 304 may be determined by parsing the existing application file (e.g., one or more of the templates 114 with advanced configuration) to determine the functions specified therein. For example, the advanced configuration 304 may include initializing an address for this particular device, determining what are the extra functions that are specified in the templates 114, and interfaces specified in the templates 114. The identified features of the advanced configuration 304 may be displayed in the graphical user interface 300.

As shown, the graphical user interface 300 includes a selectable element 310. When a user selects the selectable element 310, an interface such as graphical user interface 202 or another graphical user interface may be displayed by the software development application 108 to receive the advanced configuration 304.

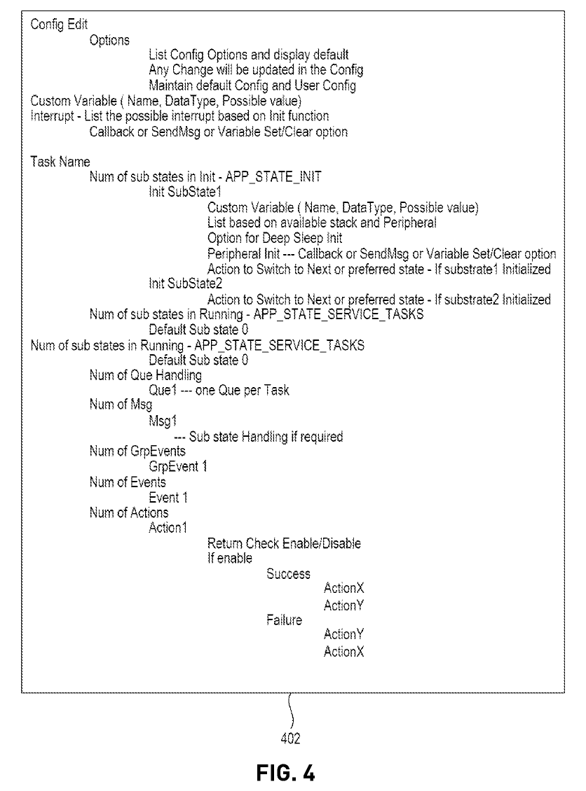

FIG. 4 illustrates an advanced configuration 402 provided by the user via the software development application 108 according to various examples. For example, by selecting selectable element 310, the software development application 108 may display one or more interfaces for receiving the advanced configuration 402. As shown, the advanced configuration 402 includes, without limitation, custom variables, custom variable types, interrupts, callbacks, tasks, state machine states, and pseudocode. Other examples of advanced configuration 402 include, but are not limited to, UML objects (e.g., diagrams), interrupt handling, state machines, state machine handling, grouping of messages, grouping of events, registering callbacks for enabled events, separating application functions based on technology or peripherals, configurable peripheral-based trigger support, or sleep support.

The advanced configuration 402 may be saved to one or more templates 114 by the software development application 108. The templates 114 may be used to generate source code, where the source code includes the base configuration 302 of FIG. 3 and the advanced configuration 402 of FIG. 4. The source code may be saved to the code repository 116. Similarly, the source code may be compiled to generate device software 118 for the target device.

Advantageously, the advanced configuration 402 or the templates 114 associated with the advanced configuration 402 may be merged into other software development projects. For example and without limitation, the other software development projects may be based on future versions of firmware, future versions of device drivers, new versions of devices, or new types of devices.

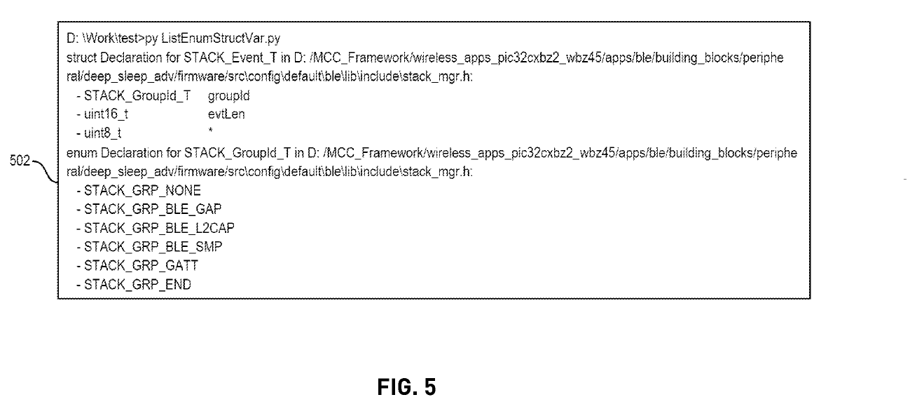

FIG. 5 illustrates a portion of code 502 for a first script from the scripts 110, according to various examples. The code 502 may be for a script that identifies the variables, interfaces, structures, enumerations, and other information in one or more templates 114, e.g., for one or more advanced configurations. The identified variables and other information may be used to merge the advanced configuration into other software projects. Examples are not limited in these contexts.

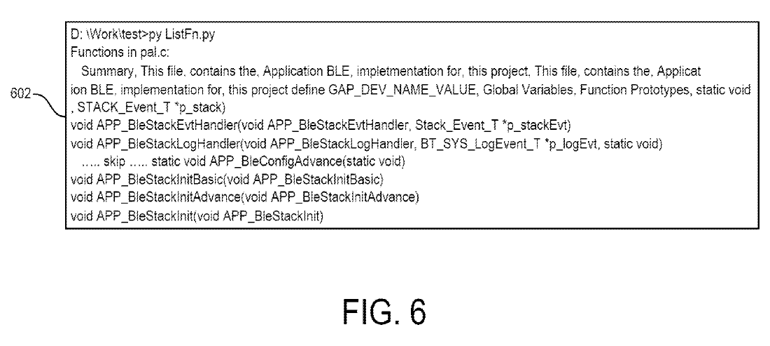

FIG. 6 illustrates a portion of code 602 for a second script from the scripts 110, according to various examples. The code 602 may be for a script that identifies the functions and other information in one or more templates 114, e.g., for one or more advanced configurations. The identified functions and other information may be used to merge the advanced configuration into other software projects. Examples are not limited in these contexts.

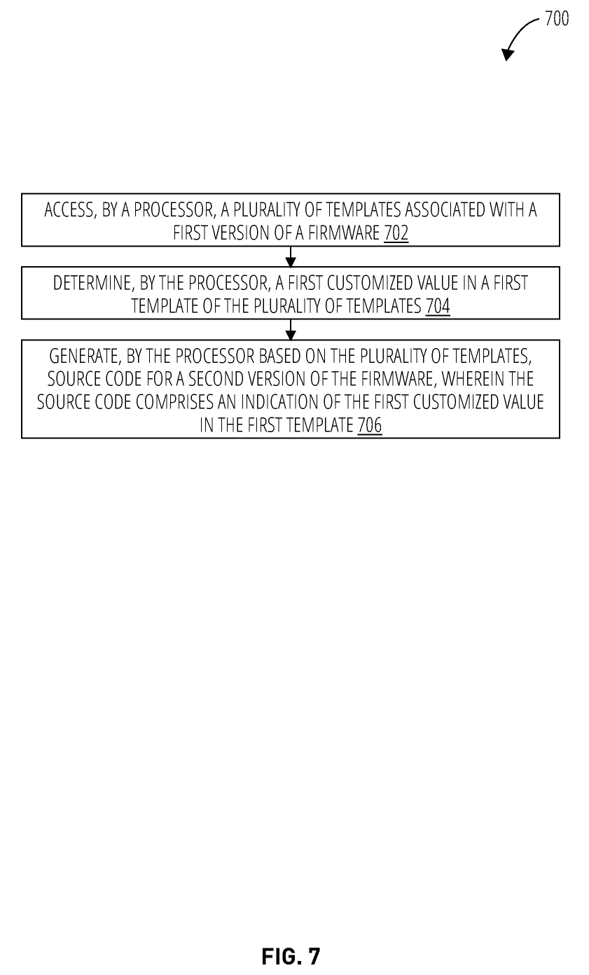

FIG. 7 illustrates an example logic flow 700. Although the example logic flow 700 depicts a particular sequence of operations, the sequence may be altered without departing from the scope of the present disclosure. For example, some of the operations depicted may be performed in parallel or in a different sequence that does not materially affect the function of the logic flow 700. In other examples, different components of an example device or system that implements the logic flow 700 may perform functions at substantially the same time or in a specific sequence.

According to some examples, the logic flow 700 includes accessing, by a processor, a plurality of templates associated with a first version of a firmware at block 702. For example, the processor 104 illustrated in FIG. 1 may access a plurality of templates in the templates 114. The templates 114 may be associated with a first version of a software development project, such as a development project for firmware of a device or device drivers of the device.

According to some examples, the logic flow 700 includes determining, by the processor, a first customized value in a first template of the plurality of templates at block 704. For example, the processor 104 may determine a first customized value in a first template of the templates 114. In some examples, one or more scripts 110 may identify the first customized value, e.g., advanced configuration specified by a user. For example, a user may specify the advanced configuration via one or more user interfaces, such as graphical user interface 202, which may be stored as one or more templates in the templates 114.

According to some examples, the logic flow 700 includes generating, by the processor based on the plurality of templates, source code for a second version of the firmware, wherein the source code comprises an indication of the first customized value in the first template at block 706. For example, the processor 104 may generate, based on the plurality of templates, source code for a second version of the firmware, where the source code comprises an indication of the first customized value in the first template from the templates 114. In some examples, the software development application 108 or one or more of the scripts 110 generates the source code at block 706. The source code generated at block 706 generally includes the advanced configuration identified at block 704, which may include the first customized value (and optionally include additional customized values). For example, the user-specified advanced configuration, entered via the graphical user interface 202, may be included in the second version of the firmware.

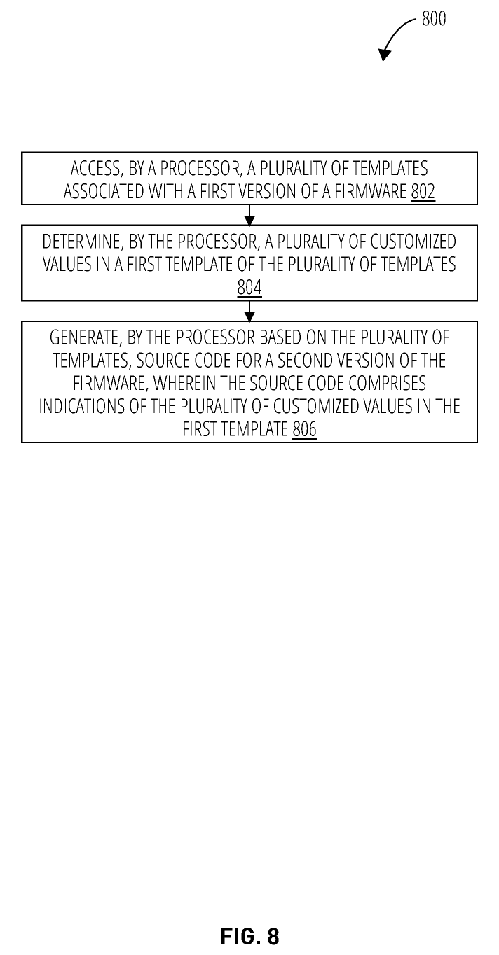

FIG. 8 illustrates an example logic flow 800. Although the example logic flow 800 depicts a particular sequence of operations, the sequence may be altered without departing from the scope of the present disclosure. For example, some of the operations depicted may be performed in parallel or in a different sequence that does not materially affect the function of the logic flow 800. In other examples, different components of an example device or system that implements the logic flow 800 may perform functions at approximately the same time or in a specific sequence.

According to some examples, the logic flow 800 includes accessing, by a processor, a plurality of templates associated with a first version of a firmware at block 802. For example, the processor 104 illustrated in FIG. 1 may access a plurality of templates in the templates 114. The templates 114 may be associated with a first version of a software development project, such as a development project for firmware of a device or device drivers of the device.

According to some examples, the logic flow 800 includes determining, by the processor, a plurality of customized values in a first template of the plurality of templates at block 804. For example, the processor 104 may determine a plurality of customized values in a first template in the templates 114. In some examples, one or more scripts 110 may identify the customized values, e.g., advanced configuration specified by a user. For example, a user may specify the advanced configuration via one or more user interfaces, such as graphical user interface 202, which may be stored as one or more templates in the templates 114.

According to some examples, the logic flow 800 includes generating, by the processor based on the plurality of templates, source code for a second version of the firmware, wherein the source code comprises indications of the plurality of customized values in the first template at block 806. For example, the processor 104 may generate, based on the plurality of templates, source code for a second version of the firmware, wherein the source code comprises indications of the plurality of customized values in the first template from the templates 114. In some examples, the software development application 108 or one or more of the scripts 110 generates the source code at block 806. The source code generated at block 806 generally includes the advanced configuration identified at block 804. For example, the user-specified advanced configuration, entered via the graphical user interface 202, may be included in the second version of the firmware.

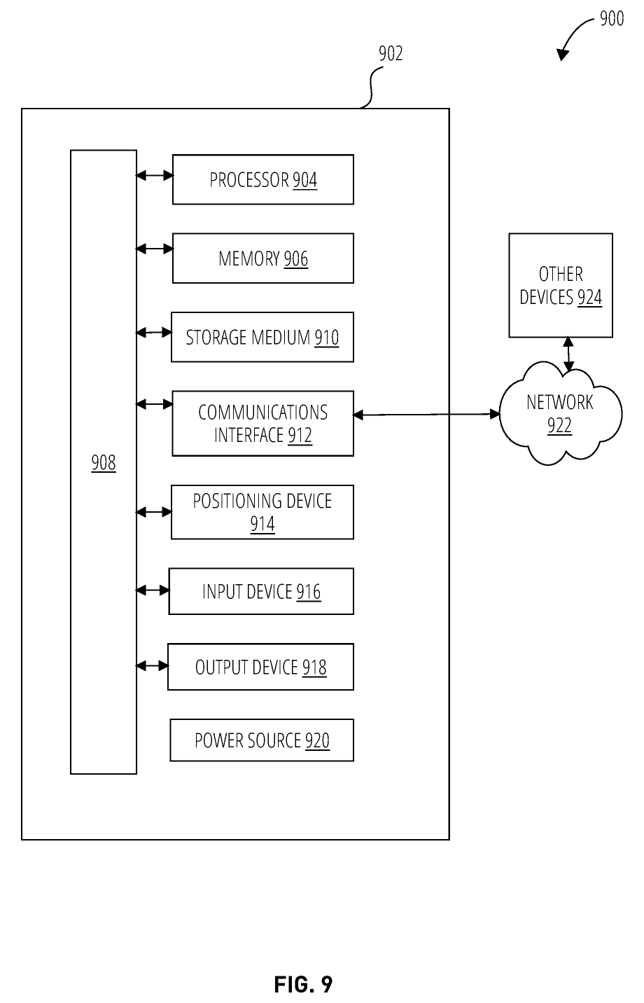

FIG. 9 illustrates an example computing system 900 suitable for implementing various examples as described herein. As shown, the computing system 900 comprises a computer 902, which is representative of any type of physical or virtualized computing device. Examples of the computer 902 include, but are not limited to, a server, workstation, laptop, mobile device, smartphone, tablet computer, mainframe, distributed computing system, compute cluster, media device, camera, gaming device, a portable digital assistant (PDA), a system-on-chip (SoC), a pager, a television, a wearable device, a virtual machine (VM), container, or any other device with processing capabilities. In one example, the computer 902 is representative of some or all of the components of the computing device 102. More generally, the computing system 900 is configured to implement all systems, methods, apparatuses, media, and examples disclosed herein.

As shown, the computer 902 includes one or more processors 904, one or more memories 906, one or more non-transitory storage media 910, one or more communications interfaces 912, one or more positioning devices 914, one or more input devices 916, and one or more output devices 918 communicably coupled via an interconnect 908. A power source 920, such as a power supply, battery, or any type of power source may provide power to the computer 902.

The processor 904 is representative of any type of processing circuit. For example, the processor 904 may be a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, a digital signal processor, analog to digital converter, digital to analog converter, and the like.

The memory 906 is representative of any computer readable medium to store data, code, or other information. The memory 906 may include volatile memory, such as volatile Random Access Memory (RAM) including a cache area for the temporary storage of data. The memory 906 may also include non-volatile memory, which can be embedded or may be removable. The non-volatile memory can additionally or alternatively include an electrically erasable programmable read-only memory (EEPROM), flash memory or the like. The storage medium 910 is representative of any type of computer readable medium to store data, code, or other information. Examples of storage media 910 include solid state drives, hard drives, Redundant Array of Independent Disks (RAID) drives, memory pools, universal serial bus (USB) storage devices, and the like.

The memory 906 and storage medium 910 can store any number and type of computer-executable instructions executed by the processor 904 to implement the functions of the computer 902 described herein. For example, the memory 906 may include software such as the software development application 108, the scripts 110, the AI models 112, the templates 114, the code repository 116, and the device software 118.

The interconnect 908 is representative of any type of circuitry to connect the components of the computer 902. For example, the interconnect 908 can include or represent, a system bus, a USB interface, a peripheral component interconnect (PCI), a Peripheral Component Interconnect-enhanced (PCIe), compute express link (CXL) interconnects, Universal Chiplet Interconnect Express (UCIe) interface, PCI-UCIe interconnects, an interface serial peripheral interconnects (SPIs), integrated interconnects (I2Cs), a high-speed interface connecting the processor 904 to the memory 906, individual electrical connections among the components, and electrical conductive traces on a motherboard common to some or all of the above-described components of the computer 902. As discussed herein, the interconnect 908 may operatively couple various components with one another, or in other words, electrically connects those components, either directly or indirectly – by way of intermediate component(s) - with one another.

The one or more input devices 916 are representative of any type of input device for receiving input, such as a keypad, keyboard, touchscreen, touchpad, microphone, camera, fingerprint sensor, mouse, joystick, other pointer device, button, soft key, and the like. The one or more output devices 918 are representative of any type of device for outputting information, such as a monitor, speaker, haptic feedback module, printer, and the like.

The computer 902 may use the communications interface 912 to communicate with one or more other devices 924 via a network 922. The communications interface 912 allows the computer 902 to communicate with and conduct transactions with other devices and systems, such as the other devices 924. The communications interface 912 may be a wired or a wireless interface. Communications may be conducted via various modes or protocols, of which Global System for Mobile Communications (GSM) voice calls, Short Message Service (SMS), Enhanced Messaging Service (EMS), Multimedia Messaging Service (MMS) messaging, Time Division Multiple Access (TDMA), Code Division Multiple Access (CDMA), Personal Digital Cellular (PDC), Wideband Code Division Multiple Access (WCDMA), CDMA2000, and General Packet Radio Service (GPRS), are all non-limiting and non-exclusive examples. Thus, communications can be conducted, for example, via the wireless communications interface 912, which can be or include a radio-frequency transceiver, a Bluetooth device, Wi-Fi device, a Near-Field Communication (NFC) device, and other wireless transceivers. In addition, a positioning device 914 such as a Global Positioning System (GPS) device may be included for navigation and location-related data exchanges, ingoing or outgoing. Wi-Fi networks use radio technologies such as the Institute of Electrical and Electronics Engineers (IEEE) 802.11x (a, b, g, n, ac, ax, be, or bn) to provide secure, reliable, fast wireless connectivity. A Wi-Fi network connects computers to each other, to the Internet, and to wired networks (which use IEEE 802.3-related media and functions). A Wi-Fi network connects computers to each other, to the Internet, and to wired networks (which use IEEE 802.3-related media and functions). Communications may also or alternatively be conducted via wired connections using the communications interface 912, e.g., using USB, Ethernet, and other physically connected modes of data transfer. The network 922 may be any one of, or the combination of, wired or wireless networks including without limitation a direct connection, a private network (e.g., an intranet), a public network (e.g., the Internet), a Personal Area Network (PAN), a Local Area Network (LAN), a Wide Area Network (WAN), a wireless network, a cellular network, and other communications networks.

The computer 902 is configured to use the communications interface 912 as, for example, a network interface to communicate with one or more other devices on a network such as network 922. In this regard, the computer 902 utilizes the wireless communications interface 912 as an antenna operatively coupled to a transmitter and a receiver (together a “transceiver”) included with the communications interface 912. The communications interface 912 is configured to provide signals to and receive signals from the transmitter and receiver, respectively. The signals may include signaling information in accordance with the air interface standard of the applicable cellular system of a wireless telephone network. In this regard, the computer 902 may be configured to operate with one or more air interface standards, communication protocols, modulation types, and access types. By way of illustration, the computer 902 may be configured to operate in accordance with any of a number of first, second, third, fourth, fifth-generation communication protocols or the like. For example, the as a smartphone, the computer 902 be configured to operate in accordance with second-generation (2G) wireless communication protocols IS-136 (time division multiple access (TDMA)), GSM (global system for mobile communication), or IS-95 (code division multiple access (CDMA)), or with third-generation (3G) wireless communication protocols, such as Universal Mobile Telecommunications System (UMTS), CDMA2000, wideband CDMA (WCDMA) or time division-synchronous CDMA (TD-SCDMA), with fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, or the like. The computer 902 may also be configured to operate in accordance with non-cellular communication mechanisms, such as via a wireless local area network (WLAN) or other communication/data networks.

The computer 902 may be under the control of any suitable operating system (not pictured). Example operating systems include, but are not limited to, Linux® operating systems, UNIX®, Windows® operating systems, macOS®, iOS®, Android®, and any other type of operating system.

The computer 902 as illustrated diagrammatically represents at least one example of a possible implementation, where alternatives, additions, and modifications are possible for performing some or all of the described methods, operations, and functions. Although shown separately, in some examples, two or more computers 902, systems, servers, or illustrated components may utilized. In some implementations, the functions of one or more systems, servers, or illustrated components may be provided by a single system or server. In some examples, the functions of one illustrated system or server may be provided by multiple systems, servers, or computing devices, including those physically located at a central facility, those logically local, and those located as remote with respect to each other.

Aspects of the present disclosure are described herein with reference to flowchart illustrations or block diagrams of computer-implemented methods and computing systems according to examples of the disclosure. It will be understood that each block of the flowchart illustrations or block diagrams, and combinations of blocks in the flowchart illustrations or block diagrams, can be implemented by computer readable program instructions that may be provided to a processor of a computer or other programmable data processing apparatus (the term “apparatus” includes systems and computer program products). The processor may execute the computer readable program instructions thereby creating a means for implementing the actions specified in the flowchart illustrations or block diagrams. These computer readable program instructions may also be stored in a computer readable storage medium that can direct a computer, a programmable data processing apparatus, or other devices to function in a particular manner, such that the computer readable storage medium having instructions stored therein comprises an article of manufacture including instructions which implement aspects of the actions specified in the flowchart illustrations or block diagrams. In particular, the computer readable program instructions may be used to produce a computer-implemented method by executing the instructions to implement the actions specified in the flowchart illustrations or block diagrams.

The computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart or block diagram block or blocks. Alternatively, computer program implemented steps or acts may be combined with operator or human implemented steps or acts to carry out an example.

In the flowchart illustrations or block diagrams disclosed herein, each block in the flowchart/diagrams may represent a module, segment, or portion of instructions, which comprises one or more executable instructions for implementing the specified logical function(s). In some implementations, the functions noted in the blocks may occur out of the order noted in the Figures. For example, two blocks shown in succession may, in fact, be executed concurrently, or the blocks may sometimes be executed in the reverse order, depending upon the functionality involved.

Computer program instructions are configured to carry out operations of the present disclosure and may be or may incorporate assembler instructions, instruction-set-architecture (ISA) instructions, machine instructions, machine dependent instructions, microcode, firmware instructions, state-setting data, source code, or object code written in any combination of one or more programming languages.

An application program may be deployed by providing computer infrastructure operable to perform one or more examples disclosed herein by integrating computer readable code into a computing system thereby performing the computer-implemented methods disclosed herein.

Although various computing environments are described above, these are examples that can be used to incorporate and use one or more examples. Many variations are possible.

The terminology used herein is for the purpose of describing particular examples and is not intended to be limiting of the disclosure. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more blocks or elements possesses those one or more blocks or elements, but is not limited to possessing those one or more blocks or elements. Likewise, a block of a method or an element of a device that “comprises”, “has”, “includes” or “contains” one or more features possesses those one or more features, but is not limited to possessing those one or more features. Furthermore, a device or structure that is configured in a certain way is configured in at least that way, but may also be configured in ways that are not listed.

The corresponding structures, materials, acts, and equivalents of all means plus function elements in the claims below, if any, are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent without departing from the scope and spirit of the disclosure. The example was chosen and described to explain the principles of one or more aspects of the disclosure and the practical application, and to enable others to understand one or more aspects of the disclosure for various examples with various modifications as are suited to the particular use contemplated.

What is claimed is:

1. A method, comprising:
accessing, by a processor, a plurality of templates associated with a first version of a firmware;
determining, by the processor, a first customized value in a first template of the plurality of templates; and
generating, by the processor based on the plurality of templates, source code for a second version of the firmware, wherein the source code comprises an indication of the first customized value in the first template.

2. The method of claim 1, wherein the first customized value is one of a plurality of customized values in the first template, wherein generating the source code comprises:
identifying, by the processor, a plurality of placeholders in the first template; and
inserting, by the processor, respective ones of the plurality of customized values into respective ones of the plurality of placeholders.

3. The method of claim 1, further comprising:
compiling, by the processor, the source code to generate an executable for the second version of the firmware for a device.

4. The method of claim 1, wherein the first version of the firmware is associated with a device, wherein the second version of the firmware is an updated version of the first version of the firmware.

5. The method of claim 1, wherein the first version of the firmware is associated with a first device, wherein the second version of the firmware is associated with a second device, wherein the second device comprises one or both of: (i) an updated version of the first device, or (ii) a different device than the first device.

6. The method of claim 1, wherein generating the source code comprises:
generating, by an artificial intelligence (AI) model based at least in part on the first template, at least a portion of the source code.

7. The method of claim 1, wherein the templates comprise FreeMarker Template Language files.

8. The method of claim 1, wherein the first customized value comprises one or more of: (i) alphanumeric values, (ii) unified modeling language (UML) objects, or (iii) pseudocode.

9. The method of claim 1, further comprising prior to accessing the plurality of templates:
receiving, by the processor, the first customized value via a graphical user interface;
generating, by the processor, the first template including the plurality of first customized value; and
storing the first template in a storage medium.

10. The method of claim 1, further comprising:
determining, by one or more scripts, a plurality of customized values including the first customized value in the first template; and
generating, by the one or more scripts, the source code including respective indications of the plurality of customized values.

11. An apparatus, comprising:
a processor; and
a memory storing instructions that, when executed by the processor, cause the processor to:
access a plurality of templates associated with a first version of a firmware;
determine a first customized value in a first template of the plurality of templates; and
generate, based on the plurality of templates, source code for a second version of the firmware, wherein the source code comprises an indication of the first customized value in the first template.

12. The apparatus of claim 11, wherein the first customized value is one of a plurality of customized values in the first template, wherein the instructions to generate the source code comprise instructions to:
identify, in the first template, a plurality of placeholders; and
insert respective ones of the plurality of customized values into respective ones of the plurality of placeholders.

13. The apparatus of claim 11, wherein the templates comprise FreeMarker Template Language files.

14. The apparatus of claim 11, wherein the first customized value comprises one or more of: (i) alphanumeric values, (ii) unified modeling language (UML) objects, or (iii) pseudocode.

15. The apparatus of claim 11, wherein the instructions to generate the source code comprise instructions to:
generate, by an artificial intelligence (AI) model based at least in part on the first template, at least a portion of the source code.

16. A non-transitory computer-readable storage medium, the computer-readable storage medium including instructions that when executed by a processor, cause the processor to:
access a plurality of templates associated with a first version of a firmware;
determine a first customized value in a first template of the plurality of templates; and
generate, based on the plurality of templates, source code for a second version of the firmware, wherein the source code comprises an indication of the first customized value in the first template.

17. The computer-readable storage medium of claim 16, wherein the first customized value is one of a plurality of customized values in the first template, wherein the instructions to generate the source code comprise instructions to:
identify, in the first template, a plurality of placeholders; and
insert respective ones of the plurality of customized values into respective ones of the plurality of placeholders.

18. The computer-readable storage medium of claim 16, wherein the templates comprise FreeMarker Template Language files.

19. The computer-readable storage medium of claim 16, wherein the first customized value comprises one or more of: (i) alphanumeric values, (ii) unified modeling language (UML) objects, or (iii) pseudocode.

20. The computer-readable storage medium of claim 16, wherein the instructions to generate the source code comprise instructions to:
generate, by an artificial intelligence (AI) model based at least in part on the first template, at least a portion of the source code.
